(19) United States
(12) Patent Application Publication
(10) Pub. No.: US 2023/0147300 A1
(43) Pub. Date: May 11, 2023

(54) MANUFACTURING DEVICE AND METHOD FOR THE ADDITIVE MANUFACTURING OF A COMPONENT PART FROM A POWDER MATERIAL, AND METHOD FOR PRODUCING A SPECIFIC INTENSITY PROFILE OF AN ENERGY BEAM

(71) Applicant: TRUMPF Laser- und Systemtechnik GmbH, Ditzingen (DE)

(72) Inventors: Matthias ALLENBERG-RABE, Ludwigsburg (DE); Valentin BLICKLE, Stuttgart (DE); Jonas GRUENEWALD, Munich (DE); Philipp WAGENBLAST, Leonberg (DE); Wilhelm MEINERS, Aachen (DE)

(21) Appl. No.: 18/149,175

(22) Filed: Jan. 3, 2023

Related U.S. Application Data
(63) Continuation of application No. PCT/EP2021/070411, filed on Jul. 21, 2021.

(30) Foreign Application Priority Data
Jul. 21, 2020 (DE) 10 2020 209 173.0
Oct. 9, 2020 (DE) 10 2020 006 217.2
Nov. 2, 2020 (DE) 10 2020 128 807.7
Nov. 24, 2020 (DE) 10 2020 131 032.3

(51) Int. Cl. B22F 10/366; B22F 12/49; B33Y 10/00; B33Y 30/00; B33Y 50/02; B23K 26/067; B23K 26/073

(52) U.S. Cl. CPC B22F 10/366; B22F 12/49; B33Y 10/00; B33Y 30/00; B33Y 50/02; B23K 26/0676; B23K 26/073; B22F 2203/03

(57) ABSTRACT

A manufacturing device for additive manufacturing of component parts from a powder material includes a beam producing device, a scanner device configured to displace an energy beam to a plurality of irradiation positions, a deflection device configured to displace the energy beam at an irradiation position to a plurality of beam positions, and a control device configured to control the deflection device and to produce a specific intensity profile in the beam region. The control device does this by dividing and displacing the energy beam to at least two beam positions separated by a distance that is variably settable and/or by displacing the energy beam and by specifying at least one operating parameter of the deflection, such as a residence time at a beam position, a beam position density distribution, a frequency distribution, and an intensity influencing parameter of the energy beam deflected to the beam positions.

### CROSS-REFERENCE TO PRIOR APPLICATION

This application is a continuation of International Application No. PCT/EP2021/070411 (WO 2022/018148 A1), filed on Jul. 21, 2021, and claims benefit to German Patent Applications No. DE 10 2020 209 173.0, filed on Jul. 21, 2020, DE 10 2020 006 217.2 filed on Oct. 9 2020, DE 10 2020 128 807.7 filed on Nov. 2, 2020, DE 10 2020 131 032.3 filed on Nov. 24, 2020. The aforementioned applications are hereby incorporated by reference herein.

### FIELD

The invention relates to a manufacturing device and a method for the additive manufacturing of a component part from a powder material, and to a method for producing a specific intensity profile of an energy beam.

### BACKGROUND

During the additive manufacturing of component parts from a powder material, an energy beam is typically displaced to predetermined irradiation positions within a work region—in particular along a predetermined irradiation path—in order to locally solidify powder material arranged in the work region. In particular, this is repeated layer-by-layer in powder material layers successively arranged in the work region in order to ultimately obtain a three-dimensional component part made of solidified powder material. Under certain circumstances, it is of benefit for various manufacturing tasks, in particular for various component parts to be produced, but also for various regions within a component part to be produced and even for various regions within the same powder material layer in the work region, to irradiate the powder material with different intensity profiles of the energy beam. In particular, an appropriate selection of the intensity profile can contribute to an increase in productivity. Producing suitable, adapted intensity profiles by means of conventional beam shaping, in particular by way of refractive or interferometric optical elements, in an optical energy beam are frequently complex and not flexibly utilizable. In particular, it is possible only with difficulty to switch between different intensity profiles during an individual manufacturing operation, very particularly within a powder material layer. Moreover, conventional methods of beam shaping allow the realization of only a limited selection of intensity profiles, and their applicability is therefore also limited.

### SUMMARY

In an embodiment, the present disclosure provides a manufacturing device for additive manufacturing of component parts from a powder material. The manufacturing device includes a beam producing device configured to produce an energy beam, a scanner device configured to displace the energy beam to a plurality of irradiation positions within a work region in order to produce a component part from the powder material arranged in the work region, a deflection device configured to displace the energy beam at an irradiation position of the plurality of irradiation positions within a beam region to a plurality of beam positions, and a control device operatively connected to the deflection device and configured to control the deflection device and to produce a specific intensity profile in the beam region. The control device does this by dividing the energy beam in order to displace the energy beam simultaneously to at least two beam positions at a distance from each other that is variably settable in at least one direction, and/or by displacing the energy beam within the beam region and by specifying at least one operating parameter of the deflection device. The at least one operating parameter may be a residence time at a beam position, a beam position density distribution in the beam region, a frequency distribution of the beam positions, or an intensity influencing parameter for influencing the intensity of the energy beam deflected in each case to the beam positions

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows an illustration of one exemplary embodiment of a manufacturing device for additive manufacturing of component parts from a powder material;

FIG. 2 shows a schematic illustration of different intensity profiles;

FIG. 3 shows a schematic illustration of a plurality of different shapes of a beam region; and

FIG. 4 shows a schematic diagram for explaining electro-optic deflection in generative manufacturing;

### DETAILED DESCRIPTION

Aspects of the disclosure proved a manufacturing device and a method for the additive manufacturing of component parts from a powder material and a method for producing a specific intensity profile of an energy beam, wherein disadvantages are at least reduced, preferably avoided.

Aspects of the present disclosure provide a manufacturing device for the additive manufacturing of component parts from a powder material, having a beam producing device that is configured for producing an energy beam. The manufacturing device additionally has a scanner device configured to displace the energy beam to a plurality of irradiation positions within a work region in order to produce a component part by means of the energy beam from the powder material arranged within the work region. In addition, the manufacturing device has a deflection device configured to displace the energy beam at an irradiation position of the plurality of irradiation positions within a beam region to a plurality of beam positions. The manufacturing device furthermore has a control device, which is operatively connected to the deflection device and is configured to control the deflection device and to produce a specific intensity profile in the beam region in a first alternative by displacing the energy beam within the beam region and specification of at least one operating parameter of the deflection device. The at least one operating parameter is selected here from a group consisting of: a residence time at a beam position, a beam position density distribution in the beam region, a frequency distribution of the beam positions, and an intensity influencing parameter for influencing the respective intensity of the energy beam deflected to the beam positions. In a second alternative, or in addition, the control device is operatively connected to the deflection device and configured to control the deflection device and to produce a specific intensity profile in the beam region due to a division of the energy beam in order to displace the energy beam simultaneously to at least two beam positions, wherein the distance between these two beam positions is variably settable in at least one direction.

In this way, in particular a specific intensity profile can be specified easily and quickly and can be produced without the associated need of special devices that are specific in particular for the intensity profile. In particular, it is easily and quickly possible to switch between different intensity profiles. The manufacturing device is consequently capable with great flexibility of producing a suitable intensity profile that is adapted to the respective component part to be produced and/or regions of a component part that are to be produced. The manufacturing device therefore exhibits in particular great productivity. Moreover, the quality of the component parts produced with the manufacturing device can be increased by selecting particularly suitable intensity profiles. Since there is no need for interferometric optical elements that are adapted specifically to the intensity profiles, in particular refractive or static ones, the manufacturing device is designed cost-effectively, despite its flexible applicability, especially under the aspect that producing different intensity profiles does not necessitate devices of different types. The manufacturing device proposed here also enables, with suitable control of the scanner device and also of the deflection device, switching between the most efficient, in particular also quick, component part manufacturing and particularly high quality manufacturing, in particular also with locally varying setting of the material properties for the resulting component part, for example a greater hardness in the region of the component part surface than inside the component part.

Additive or generative manufacturing of a component part is in particular understood to mean building up a component part from powder material layer by layer, in particular a powder-bed-based method for producing a component part in a powder bed, in particular a manufacturing method selected from a group consisting of selective laser sintering, laser metal fusion (LMF), direct metal laser melting (DMLM), laser net shaping manufacturing (LNSM), and laser engineered net shaping (LENS). Accordingly, the manufacturing device is configured in particular to carry out at least one of the aforementioned additive or generative manufacturing methods.

In general, an energy beam is understood to mean directed radiation that is able to transport energy. In general, this may be particle radiation or wave radiation. In particular, the energy beam propagates through physical space along a propagation direction and transports energy along its propagation direction in the process. In particular, local deposition of energy in the work region is possible by means of the energy beam.

In a preferred configuration, the energy beam is an optical work beam. In particular, an optical work beam is understood to mean directed, either continuous or pulsed, electromagnetic radiation which, in terms of its wavelength or a wavelength range, is suitable for additive or generative manufacturing of a component part from powder material, in particular for sintering or melting the powder material. In particular, an optical work beam is understood to mean a laser beam that can be produced continuously or in pulsed fashion. The optical work beam preferably has a wavelength or a wavelength range within the visible electromagnetic spectrum or within the infrared electromagnetic spectrum or within the overlap range between the infrared range and the visible range of the electromagnetic spectrum.

In particular, a work region is understood to mean a region, in particular a plane or surface, in which the powder material is arranged and is locally irradiated with the energy beam to locally solidify the powder material. In particular, the powder material is arranged sequentially in layers in the work region and locally irradiated with the energy beam in order to produce—layer by layer—a component part.

An irradiation position is understood to mean, in particular, a location within the work region at which energy is deposited locally into the work region, in particular into the powder material arranged there, by means of the energy beam. The scanner device is preferably configured to displace the energy beam within the work region along an irradiation path, wherein the irradiation path consists of a temporal sequence of irradiation positions over which the energy beam is swept successively. In this case, the individual irradiation positions may be arranged spaced apart from one another, or may otherwise overlap. In particular, the irradiation path can be a path that is continuously scanned by the energy beam.

In particular, a beam region is here understood to mean a region at an irradiation position within which the specific intensity profile is produced. The beam region here has in particular a two-dimensional extent that is greater than a cross section of the energy beam projected onto the work region.

The deflection device is consequently configured in particular to displace the energy beam at a fixed irradiation position, in particular at each irradiation position, within the beam region and to thereby irradiate, at the fixed irradiation position, a specific region—the beam region—within the work region with the energy beam, said region being larger than the cross section of the energy beam projected onto the work region; by contrast, the scanner device is configured to displace the energy beam between the individual irradiation positions and thereby in turn to enable the deflection device to sweep the energy beam over a new beam region at a different location. The deflection device therefore serves for a local deflection of the energy beam at an irradiation position, while the scanner device serves for the global displacement of the energy beam within the work region.

Thus the scanner device and the deflection device differ in particular with regard to a length scale of the possible displacement, wherein the scanner device is preferably configured to sweep the energy beam over the entire work region, wherein the deflection device is configured to deflect the energy beam locally at an irradiation position, specified by the scanner device, within the beam region, with the respective beam region being much smaller than the work region. In particular, the beam region preferably has a length scale in the region of a few (that is to say less than ten) millimeters up to a few centimeters and preferably has a two-dimensional extent in the region of a few square millimeters to a few square centimeters, wherein the work region has a length scale in the region of a few decimeters up to a few meters, and preferably a two-dimensional extent in the region of a few square decimeters to a few square meters.

The scanner device for one part and the deflection device for another preferably also differ with regard to the time scale over which the deflection of the energy beam takes place. In particular, the deflection of the energy beam within the beam region by way of the deflection device preferably takes place on a shorter time scale, in particular a very much shorter time scale, than the deflection within the work region by way of the scanner device, that is to say than the change from one irradiation position to the next irradiation position. In this way, a specific intensity profile can be produced quasi-statically by suitable displacement of the energy beam within the beam region by means of the deflection device advantageously at each irradiation position specified by an instantaneous setting of the scanner device. The time scale over which the energy beam can be deflected by the deflection device is preferably smaller by a factor of 10 to 1000, preferably 20 to 200, preferably 40 to 100, or more, than the time scale over which the energy beam is deflected by the scanner device.

The intensity profile produced is quasi-static in particular also in view of the melting process in the powder material, with the time scale for the deflection of the energy beam by the deflection device being significantly shorter than the characteristic interaction time between energy beam and the powder material. Averaged over time, the dynamically generated intensity profile thus interacts with the powder material like a statically produced intensity profile.

In particular, an intensity profile is here understood to mean a surface power density distribution on a surface irradiated with the energy beam, in particular a surface over which the energy beam is swept. The intensity profile thus includes in particular, as parameters that are preferably variable separately from one another, the local surface power density, in particular the intensity of the energy beam, and also the spatial distribution of the surface power density. The term “power” relates in particular to the power averaged over the time scale of the production of a quasi-static intensity profile within a beam region at one of the irradiation positions.

The at least one operating parameter of the deflection device is in particular a displacement parameter or an intensity influencing parameter.

A displacement parameter is here in particular understood to mean a parameter that at least partially determines the displacement of the energy beam within the beam region. In particular, the displacement parameter determines for example how long the energy beam resides at a specific beam position, how different beam positions within the beam region are arranged in relation to one another, and how or how often the energy beam is moved to specific beam positions. In particular, the following operating parameters are therefore displacement parameters: the residence time at a beam position, the beam position density distribution in the beam region, and the frequency distribution of the beam positions.

A residence time at a beam position is here in particular the time interval for which the energy beam resides at a specific beam position within the beam region before it is displaced to a next beam position. The residence time consequently directly determines the energy deposited at the beam position. Preferably, the residence time can also be given by a displacement speed of the energy beam in the beam region.

A beam position density distribution in the beam region is in particular understood to mean the manner in which a surface density of the beam positions in the beam region is configured, in particular how high the surface density of the beam positions is and whether the surface density of the beam positions in the beam region is homogeneous, that is to say in particular constant, or varies, and also whether and possibly how the surface density of the beam positions in the beam region varies. The local intensity in the beam region is higher here, the higher the surface density of the beam positions is, wherein the local intensity is the lower, the lower the surface density of the beam positions is. The beam position density distribution is preferably given in particular by the distances between adjacent beam positions within the beam region.

A frequency distribution of the beam positions is in particular understood to mean a measure of how frequently the energy beam is moved to or irradiates the individual beam positions within the beam region. In particular, a configuration is possible in which the energy beam—possibly with a constant residence time at the different beam positions—reaches at least some of the beam positions multiple times. If a homogeneous, that is to say constant, beam position density distribution in the beam region is assumed, the intensity profile is flat or has a constant intensity in the beam region if the energy beam moves to all beam positions with the same frequency. An intensity profile that deviates from the constancy or homogeneity can be produced by moving the energy beam to different beam positions, or irradiating the latter with the energy beam, at different frequencies. This is because more energy is deposited at the beam positions that are addressed more frequently than at the beam positions that are struck more rarely.

An energy or fluence of the energy beam is preferably constant over time. According to a preferred configuration, the intensity distribution, that is to say the intensity profile, within the beam region consequently depends only on the corresponding specification of the at least one displacement parameter.

It is obvious in this case that the intensity profile is influenced by a corresponding selection of the residence time at a beam position, the beam position density distribution in the beam region, and/or the frequency distribution of the beam positions in the beam region.

It is thus possible to very easily and flexibly produce an intensity profile by correspondingly specifying the at least one displacement parameter in the beam region.

Alternatively or additionally, the at least one operating parameter is an intensity influencing parameter. The latter is suitable for influencing, in particular modifying, the respective intensity of the energy beam that has been deflected to the beam positions, in particular the energy or fluence of the energy beam.

According to a preferred configuration, it is possible in this way in particular with an appropriate specification of a displacement parameter and an intensity influencing parameter to smooth in particular peripheral regions of the intensity profile produced by virtue of appropriately modifying there, preferably in addition to the suitable specification of the displacement parameter, the intensity of the energy beam, in particular by—incrementally or continuously—attenuating it toward the periphery.

The intensity of the energy beam is preferably additionally or alternatively variable by modifying the intensity of the energy beam provided by the beam producing device, in particular by suitably controlling the beam producing device.

The control device is preferably selected from a group consisting of a computer, in particular a personal computer (PC), a plug-in card or control card, and an FPGA board. In a preferred configuration, the control device is an RTC6 control card by SCANLAB GmbH, in particular in the current configuration obtainable at the priority date of the present property right.

The control device is preferably configured to synchronize the scanner device with the deflection device by means of a digital RF synthesizer, wherein the RF synthesizer is controlled via a programmable FPGA board. Additionally, there preferably is a division into the comparatively slow movement of the scanner device and the fast movement of the deflection device by means of a frequency divider. Preferably, position values and specification values for a beam profile, that is to say the intensity profile and a shape of the beam region, are calculated, and these are then converted in the FPGA board into temporally synchronous frequency specifications for the RF synthesizer. Before doing so, a spatial allocation of the beam profiles to irradiation positions in the respective powder material layer is required, which is preferably performed already in a build processor. The latter writes the corresponding data into a file, which is then preferably used by the control device. Alternatively or additionally, it is preferably possible to select from predefined beam profiles.

According to a development of the invention, the control device is configured to modify the intensity profile by varying the at least one operating parameter, in particular the at least one displacement parameter and/or the at least one intensity influencing parameter. The intensity profile can advantageously thus be in particular appropriately adapted in an easy and quick manner.

According to one development of the invention, the control device is configured to produce the intensity profile as a Gaussian intensity profile. In particular, this can also be a Gaussian profile that is elongated along a direction within the work region, wherein the axis of longest extent of the Gaussian profile in the preferred configuration can extend perpendicularly to an irradiation path, that is to say an in particular local displacement direction in the work region, of the energy beam, or along the irradiation path of the energy beam. It is of course also possible that the axis of longest extent of the Gaussian profile extends at an angle to the irradiation path.

Alternatively, it is possible that the intensity profile is produced as a non-Gaussian intensity profile.

Alternatively or additionally, the control device is configured to produce the intensity profile as a constant intensity profile, in particular in the manner of a flat top beam.

Alternatively or additionally, the control device is configured to produce the intensity profile as an asymmetric or distorted intensity profile.

The control device is therefore in particular able to produce a multiplicity of different intensity profiles, in particular any intensity profiles.

According to one development of the invention, the control device is configured to additionally specify a shape of the beam region by controlling the deflection device.

A shape of the beam region is here in particular understood to mean the geometry of an external boundary of the beam region or—equivalently—a shape of the quasi-static surface within the beam region over which the energy beam is swept. This corresponds to a quasi-static cross-sectional profile of the energy radiation with which the work region is irradiated at the respective irradiation position.

The control device is preferably configured to produce the shape of the beam region as a circular shape, as an annular shape, in particular a torus or donut shape, as a polygon, as a rectangle, as an elongate shape, in particular having rounded ends, and/or as an irregular shape.

The control device is preferably in particular configured to specify a beam profile by controlling the deflection device, wherein the beam profile comprises the shape of the beam region and, in addition, the intensity profile in the beam region. The manufacturing device is consequently particularly flexibly able to adapt the irradiation of the work region using the energy beam to conditions for the manufacturing of a component part, in particular also to changing, in particular locally differing conditions.

According to a development of the invention, the control device is configured to modify the intensity profile during the production of a component part, in particular within the work region, by varying the at least one operating parameter, in particular the at least one displacement parameter and/or the at least one intensity influencing parameter. In this way, the intensity profile can be adapted flexibly to different conditions or requirements during the manufacturing of a component part. With particular preference, the control device is configured to modify the intensity profile within the same powder material layer during the layer-wise build-up of a component part by varying the at least one operating parameter. This enables a very particularly flexible adaptation of the intensity profile. For example, a different intensity profile can be selected for an external enclosing region of the resulting component part, that is, in particular for its surface, than for an internal region within the external enclosing region of the component part.

Alternatively or additionally, the control device is preferably configured to modify the shape of the beam region during the production of a component part, in particular within the work region, by varying the at least one operating parameter, in particular the at least one displacement parameter and/or the at least one intensity influencing parameter. In this way, the shape of the beam region can be adapted flexibly to different conditions or requirements during the manufacturing of a component part. With particular preference, the control device is configured to modify the shape of the beam region within the same powder material layer during the layer-wise build-up of a component part by varying the at least one operating parameter. This enables a very particularly flexible adaptation of the shape of the beam region. For example, a different shape of the beam region can be selected for an external enclosing region of the resulting component part than for an internal region within the external enclosing region of the component part.

Alternatively or additionally, the intensity profile and/or the shape of the beam region can be selected in particular depending on whether a contour, a core, an overhang region, a cover layer region, or a volume region of the resulting component part is processed.

A contour in this case is a boundary or external border of a region within a powder material layer that is to be solidified or has solidified. A core is a region inside the contour of the powder material layer.

An overhang region is a region within a powder material layer, below which, i.e. in powder material layers located below it, non-solidified powder material is present. Such an overhang is also referred to as “down skin.” This term also denotes the lowermost powder material layer that comprises solidified powder material, that is to say a bottom surface of the component part.

A cover layer region is a region within a powder material layer, above which, i.e. in powder material layers located above it, non-solidified powder material is present. Such a cover layer region is also referred to as “up skin.” This term also denotes the uppermost powder material layer that still comprises solidified powder material, that is to say a roof surface or uppermost surface of the component part.

A volume region is a region within a powder material layer that is surrounded by solidified powder material on all sides, in particular within the powder material layer but also above and below the powder material layer just processed, in the finished component part. Such a region is also referred to as “in skin.”

It is also possible to use different intensity profiles and/or shapes of the beam region for delicate structures of a component part that lie for example in the order of magnitude of the beam region, and also for coarser, larger, in particular two-dimensional, structures. If appropriate, delicate structures, in particular contained structure sections, can be produced purely by controlling the deflection device and producing a local beam profile at a fixed irradiation position without the scanner device being controlled, in particular by virtue of a beam profile in the form of the structure section to be formed being produced by suitably controlling the deflection device.

The specification of the intensity profile and/or the shape of the beam region depending on the instantaneous irradiation position also makes it possible to influence the resulting component part construction via the intensity distribution. For example, a grain structure of the resulting component part changes upon being irradiated with changed temperature gradients and solidification conditions. It is possible in this way in particular to also influence, and in particular locally vary, local strength values or surface hardnesses.

In particular, it is possible to harden the outer surface of the component part by producing a greater hardness of the solidified powder material in up skin or down skin regions in a plurality of powder material layers that are arranged immediately therebelow or thereabove. Accordingly, it is also possible in individual powder material layers to solidify contour lines in a broader extent with greater hardness.

According to one development of the invention, the deflection device is arranged upstream of the scanner device in the propagation direction of the energy beam, that is to say, the direction of propagation of the energy radiation in space. This represents a particularly suitable configuration for a flexible production of the intensity profile and/or of the shape of the beam region. The term (upstream) here refers to the fact that the deflection device is reached first by the energy beam during the propagation of the energy beam along the propagation direction, wherein the scanner device is reached by the energy beam thereafter.

According to one development of the invention, the deflection device has at least one acousto-optic deflector.

In particular, an acousto-optic deflector is understood to mean an element with a solid body which is transparent to the energy beam and to which sound waves, in particular ultrasonic waves, are applied, wherein the energy beam is deflected upon passage through the transparent solid body, in a manner dependent on the frequency of the sound waves applied to the transparent solid body. In the process, an optical grating, in particular, is produced by the sound waves in the transparent solid body. Advantageously, such acousto-optic deflectors are able to very quickly deflect the energy beam by an angular range specified by the frequency of the sound waves produced within the transparent solid body. In particular, switching speeds of up to 1 MHz can be attained in the process. In particular, the switching times for such an acousto-optic deflector are significantly faster than typical switching times for conventional scanner optical units, in particular galvanometer scanners, which are generally used to displace an energy beam within a work region of a manufacturing device of the type under discussion here. Therefore, such an acousto-optic deflector can be particularly suitably used to produce a quasi-static intensity profile in the beam region.

Modern acousto-optic deflectors deflect the energy beam into a predetermined angular range of the first order of diffraction with an efficiency of at least 90%, and so they are highly suitable as deflection device for the manufacturing device proposed here. Decisive for the high efficiency are, in particular, the employed material that is transparent to the energy beam and a suitably high intensity of the input coupled ultrasonic waves.

According to a preferred configuration, the intensity influencing parameter is specified by operating or using the at least one acousto-optic deflector as acousto-optic modulator. Alternatively or additionally, an intensity of the sound waves coupled into the transparent solid body of the at least one acousto-optic deflector is preferably specified as the intensity influencing parameter. In this way, it is possible to very easily influence the intensity of the energy beam deflected to the respective beam position. In particular, the deflected intensity of the energy beam is preferably dependent—preferably linearly—on the intensity of the sound waves radiated into the transparent solid body.

In a preferred configuration, the deflection device has two acousto-optic deflectors that are oriented non-parallel, preferably perpendicularly, to one another. A deflection of the energy beam into two directions that are non-parallel, in particular perpendicular, to one another is thus advantageously possible. The acousto-optic deflectors that are oriented non-parallel, preferably perpendicularly, to one another are preferably arranged one downstream of one another in the direction of propagation of the energy beam.

Here “downstream” is understood to mean, in particular, that one element arranged downstream of another element is reached by the energy beam after the other element during a propagation of the energy beam along the direction of propagation, analogously to the definition for “upstream” given above.

In a development of the invention, the deflection device has at least one electro-optic deflector, preferably two electro-optic deflectors oriented non-parallel, in particular perpendicularly, to one another. The deflection of electro-optic deflectors (EOD) is based on refraction upon passage through an optically transparent material. Using one or two EODs it is possible to modify the previously mentioned exemplary embodiments with acousto-optic deflectors by replacing in each case one or two of the acousto-optic deflectors with an EOD.

According to one development of the invention, the control device is configured to excite in the at least one acousto-optic deflector an acoustic wave (sound wave), in particular a standing wave, with at least two acoustic wavelengths and to preferably change at least one of the acoustic wavelengths, in particular continuously or in discrete steps.

This is advantageous in that two beam positions in the deflection direction of the deflection device can be exposed simultaneously without the region between the two beam positions being exposed to the laser beam. Moreover, the distance of the two beam positions from one another can be changed by changing one of the acoustic wavelengths. Additionally, the intensity distribution of the diffracted energy beam between the first and the second of the beam positions can be set by setting the amplitude of the two acoustic waves. An acoustic wave with more than two acoustic wavelengths is also conceivable such that the diffracted energy beam can simultaneously be guided to more than two positions. Thus, the two or more positions of the energy beam may form a line of overlapping and/or spaced apart beam positions.

In general, an advantage of the beam displacement using an AOD is that a region between start position and end position is not exposed to the laser beam as a result of changing the acoustic wavelengths in discrete steps since the periodic changes in the refractive index temporally merge into one another substantially without forming a diffractive transition behavior. Accordingly, the energy input is restricted to the start position and the end position; this corresponds to an abrupt change in the acousto-optic deflection.

In a preferred configuration, the control device is configured to also excite in a second acousto-optic deflector an acoustic wave, in particular a standing wave, with at least two acoustic wavelengths and to preferably change at least one of the acoustic wavelengths, in particular continuously or in discrete steps.

In addition to the previously mentioned advantages, this enables the diffracted energy beam to be simultaneously guided to beam positions arranged in the manner of a grid. In the simplest case with two acousto-optic deflectors oriented perpendicularly to one another and having in each case two different wavelengths, it is possible for example to create a grid of four beam positions, which are arranged at the corners of a rectangle. However, more complicated grids with more than two beam positions in one or both directions of the grid are also conceivable. Furthermore, it is also possible to set independently of one another the intensity distributions of the diffracted energy beam by setting the amplitudes of the plurality of acoustic wavelengths in each of the acousto-optic deflectors. The orientation of the acousto-optic deflectors in relation to one another can also be modified, as a result of which for example diamond-shaped or parallelogram-shaped grids can be formed with four beam positions.

According to one development of the invention, the manufacturing device has a separation mirror downstream of the deflection device and upstream of the scanner device in the direction of propagation of the energy beam, which is configured to separate a zero-order partial beam of the energy beam from a first-order partial beam. Especially if the deflection device has an acousto-optic deflector, it produces, on account of its configuration analogous to an optical grating, a non-diffracted zero-order partial beam and a diffracted or deflected first-order partial beam. Only the first-order partial beam is intended to be used to irradiate the work region. With the aid of the separation mirror, it is then advantageously possible to separate the partial beams of different orders from one another and in so doing to transmit only the first-order partial beam to the work region, in particular to the scanner device. The zero-order partial beam is preferably diverted into a beam trap by the separation mirror.

This realization is correct for the use of exactly one acousto-optic deflector. If, in a preferred configuration, two acousto-optic deflectors oriented non-parallel, preferably oriented perpendicularly, to one another, are used, then the corresponding orders of diffraction should also be considered cumulatively: As useful beam, the intention ultimately is to use the partial beam which is initially incident as first-order partial beam of the first acousto-optic deflector on the second acousto-optic deflector, and is then diffracted once again as first-order partial beam by the second acousto-optic deflector. In this case, the useful beam as “first-order partial beam” is as it were a first-first-order partial beam. In order to keep the realization simple, reference is nevertheless only ever made to the first order hereinafter.

In particular, the separation mirror preferably has a passage hole in a surface that is reflective for the energy beam, through which passage hole the first-order partial beam passes the separation mirror toward the work region, in particular toward the scanner device. By contrast, the zero-order partial beam—and preferably also unwanted partial beams of higher order than the first order—are incident on the reflective surface and are diverted into the beam trap by the separation mirror.

Preferably, the separation mirror is arranged in the vicinity of an intermediate focus of a telescope. This enables the partial beams of different orders to be separated particularly cleanly.

Preferably, the separation mirror is not arranged exactly at the intermediate focus of the telescope, in particular in order to avoid damage to the separation mirror as a result of an excessively high power density of the energy beam.

Preferably, the separation mirror is arranged offset along the direction of propagation at a distance of one fifth of the focal length of the telescope from the intermediate focus, preferably upstream of the intermediate focus in the direction of propagation. This simultaneously ensures, firstly, a clean separation of the different partial beams of different orders and, secondly, a sufficiently low power density of the energy beam on the separation mirror in order to avoid damage thereto resulting from the energy beam.

The telescope is preferably a 1:1 telescope, i.e. has in particular neither a beam-reducing nor a beam-magnifying property. In particular, the telescope fulfills two tasks, specifically besides the separation of the different partial beams of different orders also preferably additionally the imaging of a beam rotation point, also referred to as pivot point, onto a point downstream of the telescope in the direction of propagation, wherein the imaged beam rotation point preferably comes to lie either on a pivot point of the downstream scanner device or on a point of smallest aperture.

This consideration, too, strictly speaking, is applicable only to the use of a single acousto-optic deflector. If two acousto-optic deflectors that are oriented non-parallel, preferably oriented perpendicularly, to one another are used, two beam rotation points are obtained, specifically one beam rotation point per acousto-optic deflector. However, if the two acousto-optic deflectors are arranged as close as possible one downstream of another in the direction of propagation, to a good approximation an individual, imaginary common beam rotation point can be assumed, which is then arranged between the acousto-optic deflectors.

According to one development of the invention, the scanner device has at least one scanner, in particular a galvanometer scanner, a piezo-scanner, a polygon scanner, a MEMS scanner, and/or a work head or processing head that is displaceable relative to the work region. The scanner devices proposed here are especially suitable for displacing the energy beam between a plurality of irradiation positions within the work region.

A work head or processing head that is displaceable relative to the work region is understood here to mean in particular an integrated component part of the manufacturing device which has at least one radiation outlet for at least one energy beam, wherein the integrated component part, that is to say the work head, as a whole is displaceable along at least one displacement direction, preferably along two mutually perpendicular displacement directions, relative to the work region. Such a work head can in particular be embodied with a gantry design or be guided by a robot. In particular, the work head can be embodied as a robot hand of a robot.

According to one development of the invention, the beam producing device is embodied as a laser. The energy beam is thus advantageously produced as an intensive beam of coherent electromagnetic radiation, in particular coherent light.

According to one development of the invention, the manufacturing device is configured for selective laser sintering. Alternatively or additionally, the manufacturing device is configured for selective laser melting. These configurations of the manufacturing device have proved to be particularly advantageous.

According to one development of the invention, the manufacturing device is configured such that the time scale on which the energy beam can be deflected by the deflection device is smaller by a factor of 10 to 1000, preferably 20 to 200, preferably 40 to 100, or more, than the time scale on which the energy beam is deflected by the scanner device. Of course, in addition to the deflection device, the scanner device too could be provided with a very high dynamic in the same order of magnitude as the deflection device, but the productivity gains that are achievable thereby typically do not justify the required additional costs, and so it is sufficient for example if the scanner device has one of the previously mentioned exemplary embodiments and only the deflection device can be deflected on one of the aforementioned shorter time scales.

The object is also achieved by creating a method for producing a specific intensity profile of an energy beam in a beam region on a work region of a manufacturing device for the additive manufacturing of component parts from a powder material. In a first alternative, the specific intensity profile is here produced by displacing the energy beam within the beam region and specifying at least one operating parameter for the energy beam, wherein the at least one operating parameter is selected from a group consisting of: a residence time at a beam position in the beam region, a beam position density distribution in the beam region, a frequency distribution of the beam positions in the beam region, and an intensity influencing parameter for influencing the respective intensity of the energy beam deflected to the beam positions. The specific intensity profile is produced, in a second alternative or additionally, by the energy beam being divided, as a result of which the energy beam is displaced simultaneously to at least two beam positions, wherein the distance between these two beam positions in at least one direction is variably settable. In particular the advantages that have already been explained in connection with the manufacturing device are afforded in connection with the method.

According to one development of the invention, additionally a specific shape of the beam region is produced by way of a specification of the at least one operating parameter. Thus it is possible, in a highly flexible manner, to produce both the intensity profile and also the specific shape of the beam region.

According to one development of the invention, the shape of the beam region and/or the intensity profile is/are modified by varying the at least one operating parameter. In this way, the beam region can be highly flexibly adapted regarding its shape and/or regarding its intensity profile, in particular to existing requirements and/or for increasing productivity.

According to one development of the invention, the intensity profile is additionally produced, preferably modified, by changing the intensity of the energy beam provided by the beam producing device, in particular by controlling the beam producing device. Advantageously, a further degree of freedom is thus available for influencing the intensity of the energy beam. Such influencing is possible in a particularly simple manner if a laser in which the intensity of the energy produced can be easily and quickly modified is used as the beam producing device.

According to one development of the invention, the time scale on which the energy beam is deflected within the beam region by a deflection device is smaller by a factor of 10 to 1000, preferably 20 to 200, preferably 40 to 100, or more, than the time scale on which the energy beam is deflected by a scanner device. In particular the advantages that have already been described in the embodiment of the manufacturing device are afforded in connection with this method.

Ultimately, the object is also achieved by creating a method for the additive manufacturing of a component part from a powder material. A manufacturing device according to the invention or a manufacturing device according to any of the previously described exemplary embodiments is used in connection with the method. Alternatively or additionally, a method according to the invention for producing a specific intensity profile of an energy beam or such a method in accordance with any of the previously described embodiments is used in connection with the method. In connection with the method for additive manufacturing, in particular the advantages that were already described in connection with the manufacturing device and/or the method for producing a specific intensity profile are obtained.

In a preferred configuration, the shape of the beam region and/or the intensity profile are modified during the production of the component part, in particular within the work region, in particular within the same powder material layer during the layer-wise build-up of a component part, by varying the at least one operating parameter.

The invention is explained in more detail below on the basis of the drawing, in which:

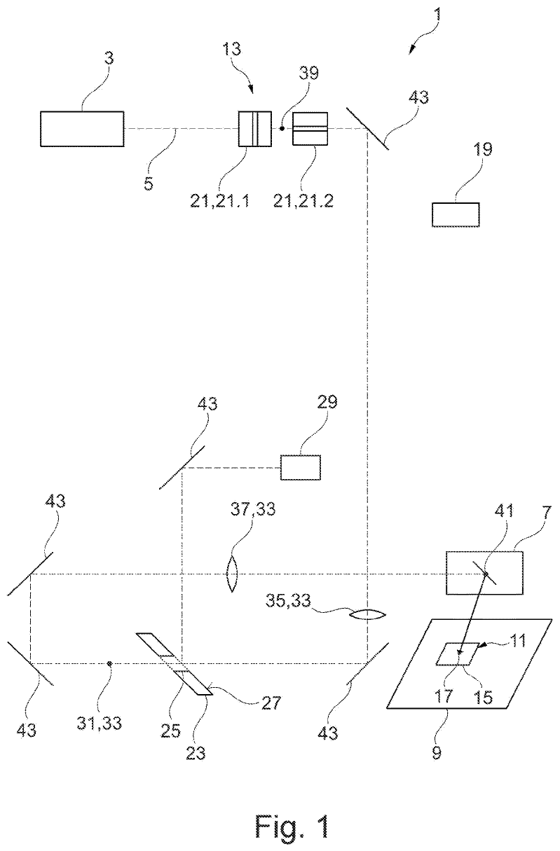

FIG. 1 shows an illustration of one exemplary embodiment of a manufacturing device for additive manufacturing of component parts from a powder material;

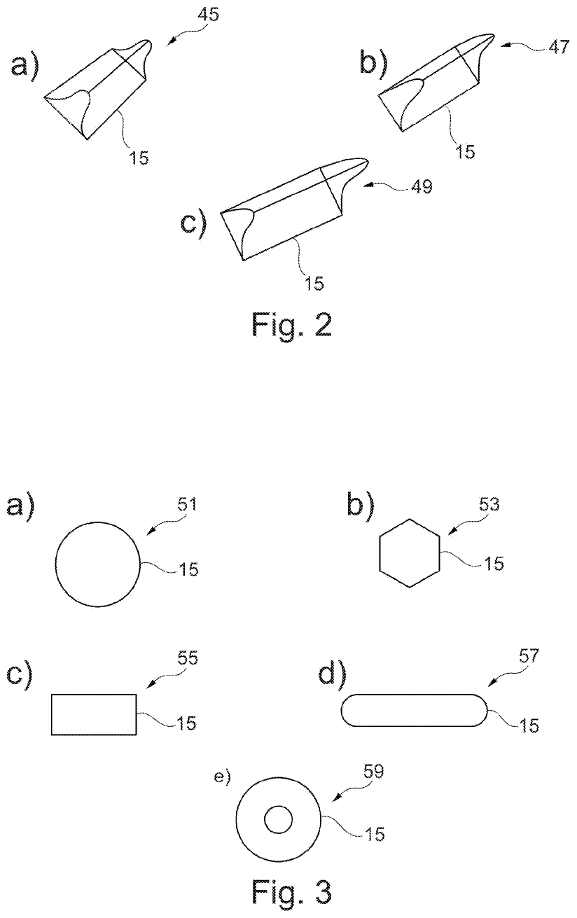

FIG. 2 shows a schematic illustration of different intensity profiles,

FIG. 3 shows a schematic illustration of a plurality of different shapes of a beam region, and

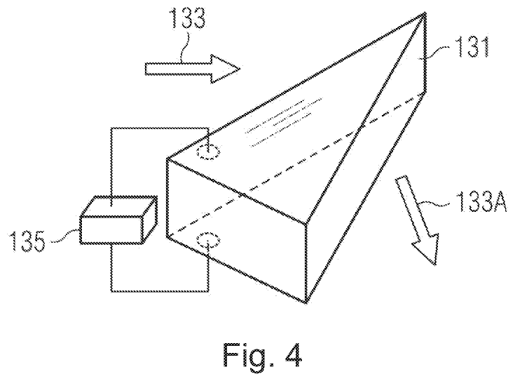

FIG. 4 shows a schematic diagram for explaining electro-optic deflection in generative manufacturing.

FIG. 1 shows a schematic illustration of one exemplary embodiment of a manufacturing device 1 configured for the additive manufacturing of component parts from a powder material. The manufacturing device 1 has a beam producing device 3 configured to produce an energy beam 5. The manufacturing device 1 additionally has a scanner device 7 configured to displace the energy beam 5 to a plurality of irradiation positions 11 within a work region 9 in order to produce a component part from the powder material arranged in the work region 9 by means of the energy beam 5.

The manufacturing device 1 has a deflection device 13 configured to displace the energy beam 5 at an irradiation position 11 of the plurality of irradiation positions 11 within a beam region 15 to a plurality of beam positions 17.

The manufacturing device 1 has a control device 19, which is operatively connected to the deflection device 13 and is configured to control the deflection device 13 and to produce a specific intensity profile in the beam region 15 by specification of at least one operating parameter of the deflection device 13. The at least one operating parameter is selected here from a group consisting of: a residence time at a beam position 17, a beam position density distribution in the beam region 15, a frequency distribution of the beam positions 17, and an intensity influencing parameter for influencing the intensity of the energy beam 5 deflected in each case to the beam positions 17.

In this way it is possible in a simple and highly flexible manner to realize a specific intensity profile in particular as a quasi-static intensity profile, wherein in particular even complex intensity profiles can be readily realized that otherwise can be realized only with difficulty or not at all with conventional beam-shaping elements, in particular as static intensity profiles.

The at least one operating parameter of the deflection device is in particular a displacement parameter or an intensity influencing parameter.

The control device 19 is configured in particular to modify the intensity profile by varying the at least one operating parameter.

In particular, the control device 19 is configured to generate the intensity profile as a Gaussian, non-Gaussian, constant, asymmetric or distorted intensity profile.

In particular, the control device 19 is configured to additionally specify a shape of the beam region 15, wherein the control device 19 is configured in particular to specify a beam profile, comprising the shape of the beam region 15 and the intensity profile in the beam region 15, by controlling the deflection device 13.

In particular, the control device 19 is configured to modify the intensity profile and/or the shape of the beam region 15 during the production of a component part, in particular within the work region 9, by varying the at least one operating parameter. In particular, this can be carried out within the same powder material layer, for example in order to expose different regions of the powder material layer, in particular an enclosing region for one part and an inner region, for the other, to different intensity profiles and/or shapes of the beam region. Alternatively or additionally, the intensity profile and/or the shape of the beam region can be selected in particular depending on whether a contour, a core, an overhang region, a cover layer region, or a volume region of the resulting component part is processed.

The deflection device 13 is arranged in particular upstream of the scanner device 7 in the direction of propagation of the energy beam 5.

In particular, the deflection device 13 has at least one acousto-optic deflector 21, in this case in particular two acousto-optic deflectors 21 oriented non-parallel, preferably oriented perpendicularly, to one another, specifically a first acousto-optic deflector 21.1 and a second acousto-optic deflector 21.2. The acousto-optic deflectors 21, here in particular oriented perpendicularly to one another, allow a deflection of the energy beam 5 in two mutually perpendicular directions and hence, in particular, allow two-dimensional scanning of the beam region 15. The acousto-optic deflectors 21 are preferably additionally controlled as acousto-optic modulators, and/or the intensity of sound waves coupled into the transparent solid body of at least one acousto-optic deflector 21 of the two acousto-optic deflectors 21 is varied in order to vary the intensity of the energy beam 5.

The manufacturing device 1 additionally has a separation mirror 23 downstream of the deflection device 13 and upstream of the scanner device 7 in the direction of propagation of the energy beam 5, said separation mirror being configured to separate a zero-order partial beam from a first-order partial beam of the energy beam 5. To this end, the separation mirror 23 has a passage hole 25, in particular, which is provided in a surface 27 of the separation mirror 23 that is reflective for the energy beam 5 and which completely penetrates through the separation mirror 23. The first-order partial beam that is intended to be transmitted to the scanner device 7 in a desired manner is guided through the passage hole 25 in this case and thus finally arrives at the scanner device 7. The unwanted zero-order partial beam and optionally also unwanted higher order partial beams, by contrast, are incident on the reflective surface 27 and are diverted to a beam trap 29.

In particular, the separation mirror 23 is arranged in the vicinity of an intermediate focus 31 of a telescope 33, in particular not exactly in a plane of the intermediate focus 31, particularly preferably offset along the direction of propagation at a distance of one fifth of the focal length of the telescope 33, in particular upstream of the intermediate focus 31. Advantageously, this prevents the reflective surface 27 from being impinged on by an excessively high power density of the energy beam 5.

The telescope 33 preferably has a first lens 35 and a second lens 37. It is preferably designed as a 1:1 telescope. Preferably, the telescope 33 has a focal length of 500 mm.

The functionality of the telescope 33 is preferably two-fold: Firstly, the telescope 33 enables a particularly advantageous and clean separation of the different orders of the energy beam 5 deflected by the deflection device 13, especially in the case of the arrangement of the separation mirror 23 chosen here; secondly, the telescope 33 preferably images an imaginary, common beam rotation point 39 of the deflection device 13 advantageously onto a pivot point 41 of the scanner device 7.

Alternatively, the telescope 33 preferably images the beam rotation point 39 onto a point of smallest aperture.

To facilitate a compact arrangement of the manufacturing device 1, the energy beam 5 is preferably diverted a number of times by diverting mirrors 43.

The scanner device 7 preferably has at least one scanner, in particular a galvanometer scanner, a piezo-scanner, a polygon scanner, a MEMS scanner, and/or a work head.

The beam producing device 3 is preferably embodied as a laser.

The manufacturing device 1 is preferably configured for selective laser sintering and/or for selective laser melting.

As part of a method for producing a specific intensity profile of the energy beam 5 in the beam region 15 on the work region 9, the specific intensity profile is preferably produced by specifying the at least one operating parameter for the energy beam that is selected from the group consisting of the residence time at a beam position 17 in the beam region 15, the beam position density distribution in the beam region 15, the frequency distribution of the beam positions 17 in the beam region 15, and an intensity influencing parameter for influencing the intensity of the energy beam 5 deflected in each case to the beam positions 17.

Additionally, a specific shape of the beam region 15 is preferably produced by specifying the at least one operating parameter.

The shape of the beam region 15 and/or the intensity profile is/are preferably modified by varying the at least one operating parameter.

As part of a method for the additive manufacturing of a component part from a powder material, preferably the manufacturing device 1 proposed here is used, and/or a method of the previously described type is used. Preferably, the shape of the beam region 15 and/or the intensity profile are modified during the production of the component part, in particular within the work region 9, by varying the at least one operating parameter.

The intensity profile is preferably additionally produced, preferably modified, by varying the intensity of the energy beam 5 provided by the beam producing device 3, in particular by controlling the beam producing device 3.

FIG. 2 shows a schematic illustration of a plurality of intensity profiles in the beam region 15, as can be produced by way of example with the deflection device 13.

Here, a) shows a first, Gaussian intensity profile 45.

In b), a second, non-Gaussian intensity profile 47 is illustrated, in which in particular the maximum of the intensity profile is shifted within the beam region 15, preferably toward a front of a displacement direction of the beam region 15 on the work region 9.

In c), a third, asymmetric or distorted intensity profile 49 is shown, in which not only in particular the maximum is arranged off-center within the beam region 15, but additionally also the intensity profile has on the right-hand side a significantly higher intensity than on the left-hand side in the beam region 15.

FIG. 3 shows a schematic illustration of a plurality of shapes of the beam region 15.

In this case, a first, circular shape 51 for the beam region 15 is illustrated in a).

A second, polygonal, here in particular hexagonal, shape 53 for the beam region 15 is illustrated in b).

A third, rectangular shape 55 for the beam region 15 is illustrated in c).

A fourth, elongated shape 57 for the beam region 15 having rounded ends is illustrated in d).

Finally, a fifth, ring-shaped, torus-shaped or donut-shaped shape 59 for the beam region 15 is illustrated in e).

FIG. 4 schematically shows a settable deflection of the energy beam 5 using an EOD 131, with the optically transparent material of the EOD 131 being settable in terms of refractive index or in terms of a refractive index gradient by way of the application of a voltage. The deflection of a laser beam 133 varies depending on the applied voltage, said laser beam preferably again being incident on the EOD 131 at the Brewster angle and emerging from said EOD at a correspondingly settable deflection angle. A laser beam 133A deflected thus could be fed to the scanner device 7 in the arrangement of FIG. 1. A voltage source 135 enables a precise setting of the voltage, which is applied, for example, between the upper and lower sides of the prism-shaped crystal forming the EOD 131 in FIG. 3. The refractive index or the refractive index gradient, and hence the deflection of the energy beam 5, can be set depending on the set voltage. With regard to the refraction behavior present at the EOD, reference is supplementarily made to “Electro-optic and acousto-optic laser beam scanners”; Römer G.R.B.E. et al., Physics Procedia 56 (2014) 29-39.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A manufacturing device for additive manufacturing of component parts from a powder material, comprising
a beam producing device configured to produce an energy beam,
a scanner device configured to displace the energy beam to a plurality of irradiation positions within a work region in order to produce a component part from the powder material arranged in the work region by means of the energy beam,
a deflection device configured to displace the energy beam at an irradiation position of the plurality of irradiation positions within a beam region to a plurality of beam positions, and
a control device operatively connected to the deflection device and configured to control the deflection device and to produce a specific intensity profile in the beam region by
a.) dividing the energy beam in order to displace the energy beam simultaneously to at least two beam positions, wherein a distance between these two beam positions is variably settable in at least one direction, and/or by
b.) displacing the energy beam within the beam region and by specifying at least one operating parameter of the deflection device selected from a group consisting of: a residence time at a beam position, a beam position density distribution in the beam region, a frequency distribution of the beam positions, and an intensity influencing parameter for influencing the intensity of the energy beam deflected in each case to the beam positions.

2. The manufacturing device as claimed in claim 1, wherein the control device is configured to modify the intensity profile by varying the at least one operating parameter.

3. The manufacturing device as claimed in claim 1, wherein the control device is configured to produce the intensity profile as a Gaussian, non-Gaussian, constant, asymmetric or distorted intensity profile.

4. The manufacturing device as claimed in claim 1, wherein the control device is configured to additionally specify a shape of the beam region by controlling the deflection device.

5. The manufacturing device as claimed in claim 1, wherein the control device is configured to modify the intensity profile and/or the shape of the beam region during the production of a component part by varying the at least one operating parameter.

6. The manufacturing device as claimed in claim 1, wherein the deflection device is disposed upstream of the scanner device in a direction of propagation of the energy beam.

7. The manufacturing device as claimed in claim 1, wherein the deflection device has at least one acousto-optic deflector.

8. The manufacturing device as claimed in claim 1, wherein the deflection device has at least one electro-optic deflector.

9. The manufacturing device as claimed in claim 7, wherein the control device is configured to excite in the at least one acousto-optic deflector an acoustic wave.

10. The manufacturing device as claimed in claim 1, further comprising a separation mirror disposed downstream of the deflection device and upstream of the scanner device in a direction of propagation of the energy beam, the separation mirror being configured to separate a zero-order partial beam from a first-order partial beam of the energy beam.

11. The manufacturing device as claimed in claim 1, wherein the scanner device has at least one scanner that is displaceable relative to the work region.

12. The manufacturing device as claimed in claim 1, wherein the beam producing device is embodied as a laser.

13. The manufacturing device as claimed in claim 1, wherein the manufacturing device is configured for selective laser sintering and/or for selective laser melting.

14. The manufacturing device as claimed in claim 1, wherein the time scale on which the energy beam can be deflected by the deflection device is smaller by a factor of 10 to 1000 than a time scale on which the energy beam is deflected by the scanner device.

15. A method for producing a specific intensity profile of an energy beam in a beam region on a work region of a manufacturing device for additive manufacturing of component parts from a powder material, the method comprising
a.) dividing the energy beam so as to simultaneously displace the energy beam to at least two beam positions, wherein the distance between these two beam positions is variably settable in at least one direction, and/or by
b.) displacing the energy beam within the beam region and by specifying at least one operating parameter for the energy beam selected from a group consisting of: a residence time at a beam position in the beam region, a beam position density distribution in the beam region, a frequency distribution of the beam positions in the beam region, and an intensity influencing parameter for influencing the intensity of the energy beam deflected in each case to the beam positions.

16. The method as claimed in claim 15, wherein additionally a specific shape of the beam region is produced by specifying the at least one operating parameter.

17. The method as claimed in claim 15, wherein the shape of the beam region and/or the intensity profile is/are modified by varying the at least one operating parameter.

18. The method as claimed in claim 15, wherein the intensity profile is additionally produced by changing the intensity of the energy beam provided by the energy producing device.

19. The method as claimed in claim 15, wherein the time scale on which the energy beam is deflected within the beam region by a deflection device is smaller by a factor of 10 to 1000 than a time scale on which the energy beam is deflected by a scanner device.
